(19) United States
(12) Patent Application Publication
(10) Pub. No.: US 2024/0332559 A1
(43) Pub. Date: Oct. 3, 2024

(54) ELECTROCHEMICAL CELL

(71) Applicant: NGK INSULATORS, LTD., Nagoya-shi (JP)

(72) Inventors: Genta TERAZAWA, Nagoya-shi (JP); Toshiyuki NAKAMURA, Handa-shi (JP); Takashi SHIRATORI, Nagoya-shi (JP); Makoto OHMORI, Nagoya-shi (JP)

(21) Appl. No.: 18/599,464

(22) Filed: Mar. 8, 2024

Related U.S. Application Data
(63) Continuation of application No. PCT/JP2023/013528, filed on Mar. 31, 2023.

(51) Int. Cl. H01M 8/0258; H01M 8/0206; H01M 8/04119

(52) U.S. Cl. CPC H01M 8/0258; H01M 8/0206; H01M 8/04149

(57) ABSTRACT

An electrochemical cell includes a metal substrate having a principal surface and a plurality of connecting holes formed in the principal surface, and a cell body disposed on the principal surface. The cell body has a gas diffusion layer disposed on the principal surface, the gas diffusion layer being electrically conductive, and a first electrode layer disposed on the gas diffusion layer; a second electrode layer. The gas diffusion layer includes a first portion sandwiched between the principal surface and the first electrode layer. The first portion has a gas flow path having a length equal to 20% or more of a total thickness of the first portion in a thickness direction thereof in a cross-section of the first portion along the thickness direction.

### CROSS-REFERENCE TO RELATED APPLICATION

This is a continuation of PCT/JP2023/013528, filed on Mar. 31, 2023, the entire contents of which are hereby incorporated by reference.

### TECHNICAL FIELD

The present invention relates to an electrochemical cell.

### BACKGROUND ART

Electrochemical cells (electrolytic cells, fuel cells etc.) are conventionally known that have a cell body disposed on a metal substrate. The metal substrate has a plurality of connecting holes, which are formed in a principal surface thereof. The cell body is formed on the principal surface of the metal substrate and has a first electrode layer that covers the plurality of connecting holes, a second electrode layer, and an electrolyte layer disposed between the first electrode layer and the second electrode layer.

Here, J P 2020-079189A discloses a fuel cell having a bonding layer interposed between a metal substrate and a first electrode layer. JP 2020-079189A states that forming, in the bonding layer, through holes connected to connecting holes in the metal substrate allows a gas to be easily supplied from the connecting holes to the first electrode layer.

### SUMMARY

However, J P 2020-079189A does not give consideration to gas diffusion properties within the bonding layer, and there are therefore limitations in facilitating the supply of a gas from the connecting holes to the first electrode layer.

That is, if the gas is simply supplied from the connecting holes to the first electrode layer through the through holes in the bonding layer, the gas can only be supplied locally to the first electrode layer.

To efficiently supply the gas to the first electrode layer, it is important to diffuse the gas supplied from the connecting holes within the bonding layer.

An object of the present invention is to provide an electrochemical cell that allows a gas to be efficiently supplied to a first electrode layer.

An electrochemical cell according to a first aspect of the present invention includes: a metal substrate having a principal surface and a plurality of connecting holes formed in the principal surface; and a cell body disposed on the principal surface. The cell body has: a gas diffusion layer disposed on the principal surface, the gas diffusion layer being electrically conductive; a first electrode layer disposed on the gas diffusion layer; a second electrode layer; and an electrolyte layer disposed between the first electrode layer and the second electrode layer. The gas diffusion layer includes: a first portion sandwiched between the principal surface and the first electrode layer; and a plurality of second portions sandwiched between the plurality of connecting holes and the first electrode layer. The first portion has a gas flow path having a length equal to 20% or more of a total thickness of the first portion in a thickness direction thereof in a cross-section of the first portion along the thickness direction.

An electrochemical cell according to a second aspect of the present invention is the electrochemical cell of the first aspect, wherein the gas flow path extends in the thickness direction.

An electrochemical cell according to a third aspect of the present invention is the electrochemical cell of the second aspect, wherein a ratio of the length of the gas flow path in the thickness direction to a width of the gas flow path in a surface direction perpendicular to the thickness direction is 10 or more.

An electrochemical cell according to a fourth aspect of the present invention is the electrochemical cell of any one of the first to third aspects, wherein the gas flow path is separated from the first electrode layer.

According to the present invention, it is possible to provide an electrochemical cell that allows a gas to be efficiently supplied to the first electrode layer.

### BRIEF DESCRIPTION OF DRAWINGS

FIG. 1 is a plan view of an electrolytic cell according to an embodiment.

FIG. 2 shows an A-A cross-section of FIG. 1.

FIG. 3 is a partial enlarged view of FIG. 2.

FIG. 4 is a partial enlarged view of FIG. 2.

### DESCRIPTION OF EMBODIMENTS

### Electrolytic Cell 1

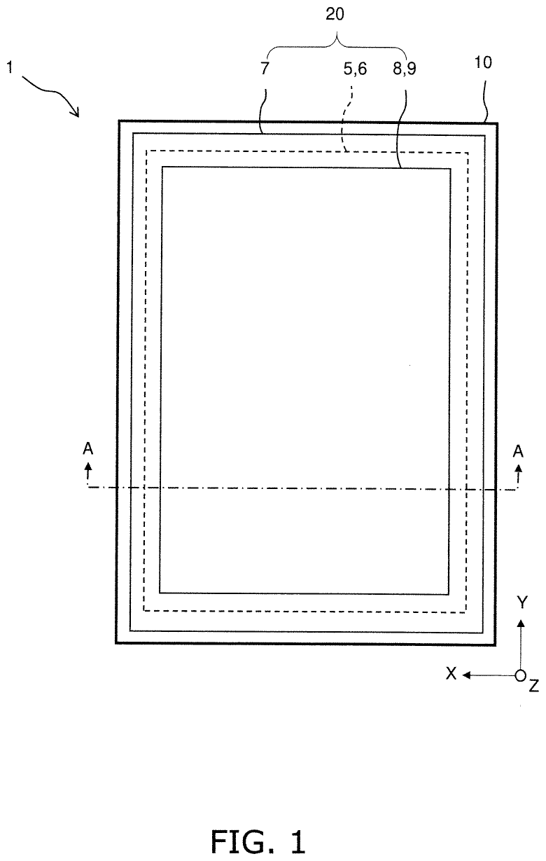

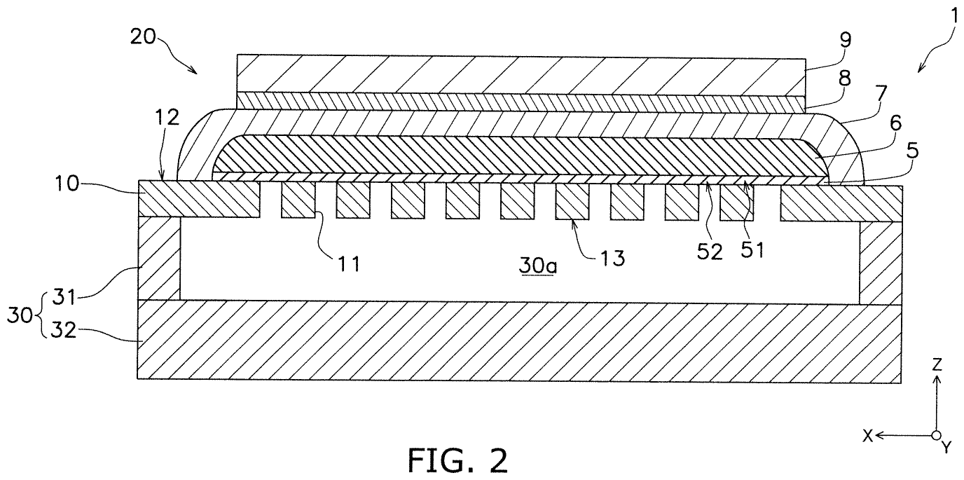

FIG. 1 is a plan view of an electrolytic cell 1 according to an embodiment. FIG. 2 shows an A-A cross-section of FIG. 1.

The electrolytic cell 1 is an example of an “electrochemical cell” according to the present invention. The electrolytic cell 1 is a so-called metal-supported electrolytic cell.

The electrolytic cell 1 has a plate shape expanding in an X-axis direction and a Y-axis direction. The electrolytic cell 1 in the present embodiment has a rectangular shape elongated in the Y-axis direction in a plan view from a Z-axis direction perpendicular to the X-axis direction and the Y-axis direction. However, the shape of the electrolytic cell 1 in the plan view is not specifically limited, and may alternatively be other than a rectangular shape, and may be a polygonal shape, an elliptic shape, a circular shape, or the like.

As shown in FIG. 2, the electrolytic cell 1 includes a metal substrate 10, a cell body 20, and a channel member 30.

### Metal Substrate 10

The metal substrate 10 supports the cell body 20. The metal substrate 10 has a plate shape. The metal substrate 10 may have a flat plate shape or a curved plate shape.

The metal substrate 10 need only be capable of supporting the cell body 20. The thickness of the metal substrate 10 is not specifically limited, but may be, for example, 0.1 mm or more and 2.0 mm or less.

As shown in FIG. 2, the metal substrate 10 has a plurality of connecting holes 11, a first principal surface 12, and a second principal surface 13.

Each connecting hole 11 extends through the metal substrate 10 from the first principal surface 12 to the second principal surface 13. Each connecting hole 11 is open in the first principal surface 12 and the second principal surface 13. In the present embodiment, the opening of each connecting hole 11 in the first principal surface 12 is covered by a later-described gas diffusion layer 5. The opening of each connecting hole 11 in the second principal surface 13 is continuous with a later-described channel 30a.

The connecting holes 11 can be formed by means of mechanical processing (e.g. punching), laser processing, chemical processing (e.g. etching), or the like.

Each connecting hole 11 in the present embodiment has a straight shape extending along the Z-axis direction. However, each connecting hole 11 may be inclined relative to the Z-axis direction, and need not necessarily has a straight shape. The connecting holes 11 may be continuous with each other.

The first principal surface 12 is an example of a “principal surface” according to the present invention. The first principal surface 12 is provided on the opposite side to the second principal surface 13. The cell body 20 is disposed on the first principal surface 12. The channel member 30 is joined to the second principal surface 13.

The metal substrate 10 is made of a metallic material. The metal substrate 10 is, for example, made of an alloy material containing Cr (chromium). Examples of such metallic materials include Fe—Cr alloy steel (stainless steel etc.) and Ni—Cr alloy steel. The content of Cr in the metal substrate 10 is not specifically limited, but can be 4% by mass or more and 30% by mass or less.

The metal substrate 10 may also contain Ti (titanium) and/or Zr (zirconium). The content of Ti in the metal substrate 10 is not specifically limited, but can be 0.01 mol % or more and 1.0 mol % or less. The content of Zr in the metal substrate 10 is not specifically limited, but can be 0.01 mol % or more and 0.4 mol % or less. The metal substrate 10 may contain Ti in the form of TiO₂ (titania) and may contain Zr in the form of ZrO₂ (zirconia).

The metal substrate 10 may have, on a surface thereof, an oxide film formed by oxidation of constituent elements of the metal substrate 10. A typical oxide film is, for example, a chromium oxide film. The chromium oxide film covers at least a portion of the surface of the metal substrate 10. The chromium oxide film may also cover at least a portion of an inner wall surface of each connecting hole 11.

### Cell Body 20

The cell body 20 is disposed on the metal substrate 10. The cell body 20 is supported by the metal substrate 10. The cell body 20 has a gas diffusion layer 5, a hydrogen electrode layer 6 (cathode), an electrolyte layer 7, a reaction-preventing layer 8, and an oxygen electrode layer 9 (anode).

The gas diffusion layer 5, the hydrogen electrode layer 6, the electrolyte layer 7, the reaction-preventing layer 8, and the oxygen electrode layer 9 are stacked in this order from the metal substrate 10 side in the Z-axis direction. The gas diffusion layer 5, the hydrogen electrode layer 6, the electrolyte layer 7, and the oxygen electrode layer 9 are essential components, and the reaction-preventing layer 8 is an optional component.

### Gas Diffusion Layer 5

The gas diffusion layer 5 is formed on the first principal surface 12 of the metal substrate 10. The gas diffusion layer 5 in the present embodiment covers the connecting holes 11 in the metal substrate 10. The gas diffusion layer 5 may be partially located within the connecting holes 11 of the metal substrate 10.

The gas diffusion layer 5 is an electrically conductive porous body. The gas diffusion layer 5 has gas diffusion properties. The gas diffusion layer 5 supplies a source gas supplied from the connecting holes 11 to the hydrogen electrode layer 6, and discharges a gas produced in the hydrogen electrode layer 6 through the connecting holes 11.

The gas diffusion layer 5 contains an electrically conductive material. The electrically conductive material may be a metallic material, such as Ni (nickel) or Fe (iron), or an electrically conductive ceramic material.

The gas diffusion layer 5 may also contain a base material that supports the electrically conductive material. The base material may be insulating. The base material can be YSZ, CSZ, ScSZ, GDC, SDC, (La, Sr) (Cr, Mn)O₃, (La, Sr) TiO₃, Sr₂(Fe, Mo)₂O₆, (La, Sr)VO₃, (La, Sr)FeO₃, LDC (lanthanum-doped ceria), LSGM (lanthanum gallate), or a mixed material of two or more of these materials.

The gas diffusion layer 5 may contain a metallic element contained in the metal substrate 10. This brings the gas diffusion layer 5 and the metal substrate 10 into more intimate contact and is therefore preferable. Note that the aforementioned electrically conductive material is different from the metallic element contained in the metal substrate 10. Accordingly, the electrically conductive material contained in the gas diffusion layer 5 need not be contained in the metal substrate 10.

The thickness of the gas diffusion layer 5 is not specifically limited, but can be, for example, 1 μm or more and 50 μm or less. The term “thickness” as used herein means the thickness in the thickness direction of the cell body 20. The term “thickness direction” refers to a direction perpendicular to a surface direction parallel to the first principal surface 12 of the metal substrate 10. The surface direction is defined by an approximate straight line of the first principal surface 12 that is obtained by the least squares method in a cross section of the metal substrate 10 along the Z-axis direction.

The method of forming the gas diffusion layer 5 is not specifically limited, and can be a sintering method, a spray coating method (thermal spray method, aerosol deposition method, aerosol gas deposition method, powder jet deposition method, particle jet deposition method, cold spray method etc.), a PVD method (sputtering method, pulsed laser deposition method etc.), a CVD method, or the like.

As shown in FIG. 2, the gas diffusion layer 5 includes a first portion 51 and a plurality of second portions 52.

The first portion 51 is a portion of the gas diffusion layer 5 that is sandwiched between the first principal surface 12 of the metal substrate 10 and the hydrogen electrode layer 6 in the thickness direction. The first portion 51 is the portion of the gas diffusion layer 5 excluding the second portions 52.

The second portions 52 are portions of the gas diffusion layer 5 between the connecting holes 11 in the metal substrate 10 and the hydrogen electrode layer 6 in the thickness direction. Since there are a plurality of connecting holes 11, there are also a plurality of second portions 52.

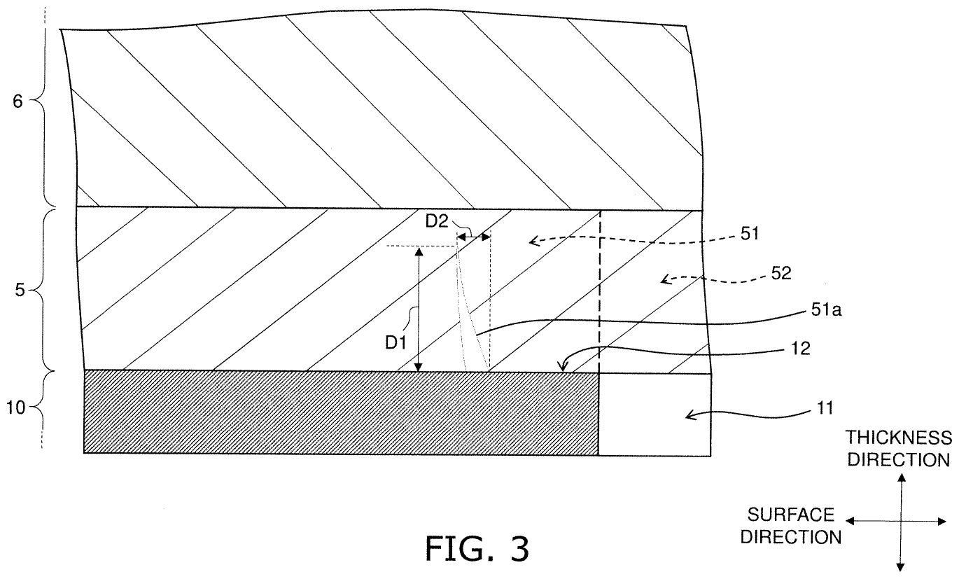

Here, FIG. 3 is a partial enlarged view of FIG. 2. FIG. 3 is a schematic enlarged view of the gas diffusion layer 5.

The first portion 51 of the gas diffusion layer 5 has a gas flow path 51a. The gas flow path 51a is a channel of the source gas supplied from the connecting holes 11 and the gas produced in the hydrogen electrode layer 6.

The gas flow path 51a have a length D1 that is 20% or more of the total thickness of the first portion 51 in the thickness direction. This allows the gas (source gas or produced gas) that has flowed into the gas flow path 51a to be efficiently distributed in the thickness direction. Since the gas flow path 51a functions as a bypass for distributing the gas in the thickness direction, the gas can be widely supplied from the gas flow path 51a to the interior of the first portion 51 as if moisture is supplied from a trunk to branches of a tree. As a result, the gas diffusion properties within the first portion 51 can be significantly improved.

It is preferable that the gas flow path 51a extends in the thickness direction. That is, it is preferable that the length D1 of the gas flow path 51a in the thickness direction is larger than a width D2 of the gas flow path 51a in the surface direction. This can prevent electrically conductive paths extending in the thickness direction within the first portion 51 from being cut by the gas flow path 51a.

It is preferable that the ratio of the length D1 of the gas flow path 51a in the thickness direction to the width D2 of the gas flow path 51a is 10 or more. This can further prevent the electrically conductive paths from being cut by the gas flow path 51a.

Although the value of the length D1 of the gas flow path 51a is not specifically limited, the length D1 can be, for example, 1 μm or more and 50 μm or less. Although the value of the width D2 of the gas flow path 51a is not specifically limited, the width D2 can be, for example, 0.2 μm or more and 0.5 μm or less.

Here, the total thickness of the first portion 51 can be obtained by measuring the total thickness of the first portion 51 at 10 randomly selected positions in a SEM image of the first portion 51 and taking an arithmetic mean of the measured values. The length D1 of the gas flow path 51a can be obtained by measuring the total length of the gas flow path 51a in the thickness direction in the SEM image of the first portion 51. The width D2 of the gas flow path 51a can be obtained by measuring the total width of the gas flow path 51a in the surface direction in the SEM image of the first portion 51.

The SEM image is acquired using an FE-SEM (Field Emission Scanning Electron Microscope) with an in-lens secondary electron detector. The observation magnification of the FE-SEM is a magnification at a level that allows the gas flow path 51a to be recognized (e.g. 5000 to 30000 times).

It is preferable that the gas flow path 51a is separated from the hydrogen electrode layer 6, as shown in FIG. 3. That is, it is preferable that an end of the gas flow path 51a on the hydrogen electrode layer 6 side is buried inside the first portion 51 and is not in contact with the hydrogen electrode layer 6. This can prevent the source gas from being directly and locally supplied to the hydrogen electrode layer 6, and can thus allow the source gas to be supplied to the entire hydrogen electrode layer 6 from the gas flow path 51a via the interior of the first portion 51.

Note that the gas flow path 51a can be formed by burying, in the thickness direction, a string-shaped pore former into a slurry (that contains the constituent material of the gas diffusion layer 5) applied to the first principal surface 12 of the metal substrate 10 when forming a compact of the gas diffusion layer 5.

Although FIG. 3 shows the gas flow path 51a that is curved in the surface direction, the shape of the gas flow path 51a can be changed as appropriate. The shape of the gas flow path 51a can be changed by adjusting the shape of the pore former.

Although FIG. 3 shows the gas flow path 51a that is in contact with the metal substrate 10 and separated from the hydrogen electrode layer 6, the position of the gas flow path 51a can be changed as appropriate. The position of the gas flow path 51a can be changed by adjusting the embedding position of the pore former.

### Hydrogen Electrode Layer 6

The hydrogen electrode layer 6 is an example of a “first electrode layer” according to the present invention. The hydrogen electrode layer 6 is formed on the gas diffusion layer 5. The hydrogen electrode layer 6 is disposed between the gas diffusion layer 5 and the electrolyte layer 7.

The source gas is supplied to the hydrogen electrode layer 6 from the connecting holes 11 via the gas diffusion layer 5. The source gas contains at least H₂O.

When the source gas contains only H₂O, the hydrogen electrode layer 6 produces H₂ from the source gas in accordance with the electrochemical reaction of water electrolysis expressed by the following chemical equation (1).

Hydrogen electrode layer6:H₂O+2e⁻→H₂+O²⁻ (1)

When the source gas contains CO₂ in addition to H₂O, the hydrogen electrode layer 6 produces H₂, CO, and O²⁻ from the source gas in accordance with the electrochemical reaction of co-electrolysis expressed by the following chemical equations (2), (3), and (4).

Hydrogen electrode layer6:CO₂+H₂O+4e⁻→CO+H₂+2O²⁻ (2)

Electrochemical reaction of H₂O:H₂O+2e⁻→H₂+O²⁻ (3)

Electrochemical reaction of CO₂:CO₂+2e⁻→CO+O²⁻ (4)

The hydrogen electrode layer 6 is an electrically conductive porous body. The hydrogen electrode layer 6 has gas diffusion properties. The source gas is supplied to the hydrogen electrode layer 6 from the gas diffusion layer 5. The hydrogen electrode layer 6 discharges a gas produced within the hydrogen electrode layer 6 toward the gas diffusion layer 5.

The hydrogen electrode layer 6 contains an electrically conductive material. The electrically conductive material may be a metallic material, such as Ni (nickel) or Fe (iron), or an electrically conductive ceramic material. In the case of co-electrolysis, Ni also functions as a thermal catalyst to promote the thermal reaction between H₂ produced and CO₂ contained in the source gas and maintain a gas composition appropriate for methanation, reverse water-gas shift reactions, or the like.

The electrically conductive material exists in an oxide state (e.g. NiO) in an oxidizing atmosphere, and exists in a metallic state (e.g. Ni) in a reducing atmosphere. The present embodiment envisions that the electrolytic cell 1 is exposed to a reducing atmosphere.

The hydrogen electrode layer 6 contains an oxide ion-conductive material. The oxide ion-conductive material is an example of an “ion-conductive material” according to the present invention. The oxide ion-conductive material can be YSZ, CSZ, ScSZ, GDC, SDC, (La, Sr) (Cr, Mn) O₃, (La, Sr) TiO₃, Sr₂ (Fe, Mo)₂O₆, (La, Sr) VO₃, (La, Sr)FeO₃, LDC, LSGM, or a mixed material of two or more of these materials.

In the present embodiment, the hydrogen electrode layer 6 has a single layer structure constituted by a single composition, but may alternatively have a multilayer structure constituted by different compositions.

The thickness of the hydrogen electrode layer 6 is not specifically limited, but can be, for example, 1 μm or more and 500 μm or less.

The method of forming the hydrogen electrode layer 6 is not specifically limited, and can be a sintering method, a spray coating method, a PVD method, a CVD method, or the like.

### Electrolyte Layer 7

The electrolyte layer 7 is disposed between the hydrogen electrode layer 6 and the oxygen electrode layer 9. In the present embodiment, the reaction-preventing layer 8 is disposed between the electrolyte layer 7 and the oxygen electrode layer 9, and the electrolyte layer 7 is therefore sandwiched between the hydrogen electrode layer 6 and the reaction-preventing layer 8.

The electrolyte layer 7 covers the hydrogen electrode layer 6 and also covers a region of the first principal surface 12 of the metal substrate 10 that is exposed from the gas diffusion layer 5.

The electrolyte layer 7 transmits O²⁻ produced in the hydrogen electrode layer 6 toward the oxygen electrode layer 9. The electrolyte layer 7 is made of an oxide ion-conductive dense material. The electrolyte layer 7 can be made of, for example, YSZ (yttria stabilized zirconia; e.g. 8YSZ), GDC (gadolinium doped ceria), ScSZ (scandia stabilized zirconia), SDC (samarium solid solution ceria), LSGM (lanthanum gallate), or the like.

The porosity of the electrolyte layer 7 is not specifically limited, but can be, for example, 0.1% or more and 7% or less. The thickness of the electrolyte layer 7 is not specifically limited, but can be, for example, 1 μm or more and 100 μm or less.

The method of forming the electrolyte layer 7 is not specifically limited, and can be a sintering method, a spray coating method, a PVD method, a CVD method, or the like.

### Reaction-Preventing Layer 8

The reaction-preventing layer 8 is disposed between the electrolyte layer 7 and the oxygen electrode layer 9. The reaction-preventing layer 8 is disposed on the opposite side to the hydrogen electrode layer 6 with respect to the electrolyte layer 7. The reaction-preventing layer 8 prevents a constituent element of the electrolyte layer 7 from reacting with a constituent element of the oxygen electrode layer 9 to form a layer with high electrical resistance.

The reaction-preventing layer 8 is constituted by an oxide ion-conductive material. The reaction-preventing layer 8 can be made of GDC, SDC, or the like.

The porosity of the reaction-preventing layer 8 is not specifically limited, but can be, for example, 0.1% or more and 50% or less. The thickness of the reaction-preventing layer 8 is not specifically limited, but can be, for example, 1 μm or more and 50 μm or less.

The method of forming the reaction-preventing layer 8 is not specifically limited, and can be a sintering method, a spray coating method, a PVD method, a CVD method, or the like.

### Oxygen Electrode Layer 9

The oxygen electrode layer 9 is an example of a “second electrode layer” according to the present invention. The oxygen electrode layer 9 is disposed on the opposite side to the hydrogen electrode layer 6 with respect to the electrolyte layer 7. In the present embodiment, the reaction-preventing layer 8 is disposed between the electrolyte layer 7 and the oxygen electrode layer 9, and the oxygen electrode layer 9 is therefore connected to the reaction-preventing layer 8. If the reaction-preventing layer 8 is not disposed between the electrolyte layer 7 and the oxygen electrode layer 9, the oxygen electrode layer 9 is connected to the electrolyte layer 7.

The oxygen electrode layer 9 produces O₂ from O²⁻ transmitted from the hydrogen electrode layer 6 via the electrolyte layer 7, in accordance with the chemical reaction expressed by the following chemical equation (5).

Oxygen electrode layer9:2O²⁻→O₂+4e⁻ (5)

The oxygen electrode layer 9 is an oxide ion-conductive and electrically conductive porous body. The oxygen electrode layer 9 can be made of, for example, a composite material of an oxide ion-conductive material (GDC etc.) and at least one of (La, Sr) (Co, Fe)O₃, (La, Sr)FeO₃, La(Ni, Fe)O₃, (La, Sr)CoO₃, and (Sm, Sr CoO₃.

The porosity of the oxygen electrode layer 9 is not specifically limited, but can be, for example, 20% or more and 60% or less. The thickness of the oxygen electrode layer 9 is not specifically limited, but can be, for example, 1 μm or more and 100 μm or less.

The method of forming the oxygen electrode layer 9 is not specifically limited, and can be a sintering method, a spray coating method, a PVD method, a CVD method, or the like.

### Channel Member 30

The channel member 30 is joined to the second principal surface 13 of the metal substrate 10. The channel member 30 forms a channel 30a between the channel member 30 and the metal substrate 10. The source gas is supplied to the channel 30a. The source gas supplied to the channel 30a is supplied to the hydrogen electrode layer 6 of the cell body 20 via the connecting holes 11 in the metal substrate 10.

The channel member 30 can be made of an alloy material, for example. The channel member 30 may be made of the same material as the metal substrate 10. In this case, the channel member 30 may be substantially integrated with the metal substrate 10.

The channel member 30 has a frame 31 and an interconnector 32. The frame 31 is an annular member that surrounds the sides of the channel 30a. The frame 31 is joined to the second principal surface 13 of the metal substrate 10. The interconnector 32 is a plate-shaped member for electrically connecting an external power source or another electrolytic cell to the electrolytic cell 1 in series. The interconnector 32 is joined to the frame 31.

The frame 31 and interconnector 32 in the present embodiment are separate members, but the frame 31 and interconnector 32 may alternatively be an integrated member.

### Specific Configuration of Gas Diffusion Layer 5 and Hydrogen Electrode Layer 6

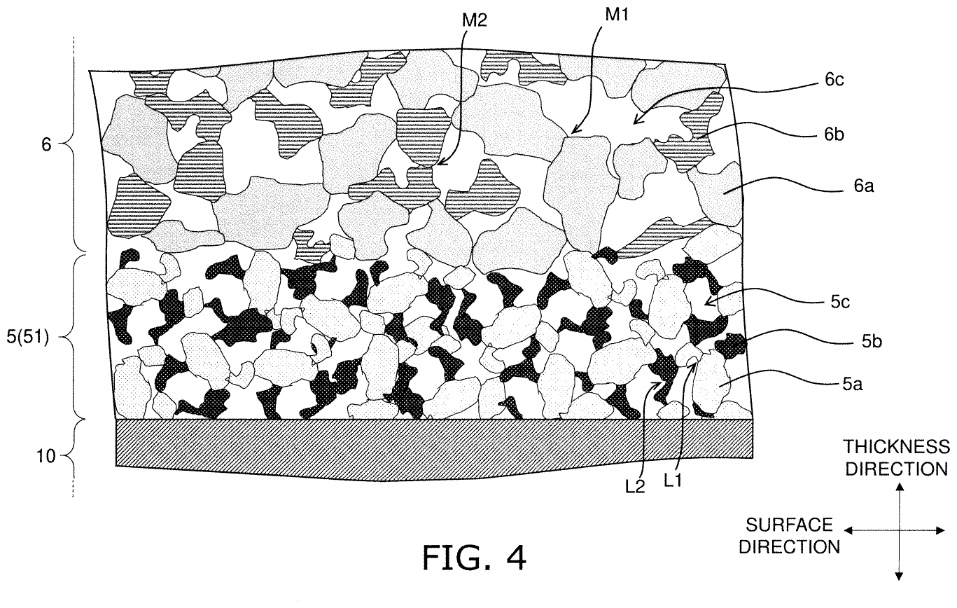

FIG. 4 is a partial enlarged view of FIG. 2. FIG. 4 schematically shows cross sections of the gas diffusion layer 5, the hydrogen electrode layer 6, and the metal substrate 10 along the thickness direction. Note that FIG. 4 shows the first portion 51 of the gas diffusion layer 5.

The gas diffusion layer 5 has a plurality of first electrically conductive particles 5a, a plurality of base material particles 5b, and a plurality of first pores 5c. The plurality of first electrically conductive particles 5a and the plurality of first pores 5c are essential constituents, and the plurality of the base material particles 5b are optional constituents.

The first electrically conductive particles 5a are connected to each other. This forms electrically conductive paths extending in the thickness direction within the gas diffusion layer 5. The first electrically conductive particles 5a are connected to each other at neck portions L1. The neck portions L1 are formed by mass transfer between the first electrically conductive particles 5a during heating when forming the gas diffusion layer 5.

The base material particles 5b are connected to each other. This forms a skeleton that holds the electrically conductive paths. The base material particles 5b are connected to each other at neck portions L2. The neck portions L2 are formed by mass transfer between the base material particles 5b during heating when forming the gas diffusion layer 5.

The first pores 5c are connected to each other. This forms gas flow paths expanding three-dimensionally within the gas diffusion layer 5. The first pores 5c are voids between the first electrically conductive particles 5a and the base material particles 5b.

The hydrogen electrode layer 6 has a plurality of second electrically conductive particles 6a, a plurality of ion-conductive particles 6b, and a plurality of second pores 6c.

The second electrically conductive particles 6a are connected to each other. This forms electrically conductive paths extending in the thickness direction within the hydrogen electrode layer 6. The second electrically conductive particles 6a are connected to each other at neck portions M1. The neck portions M1 are formed by mass transfer between the second electrically conductive particles 6a during heating when forming the hydrogen electrode layer 6.

The ion-conductive particles 6b are connected to each other. This forms ion-conductive paths expanding three-dimensionally within the hydrogen electrode layer 6. The ion-conductive particles 6b are connected to each other at neck portions M2. The neck portions M2 are formed by mass transfer between the ion-conductive particles 6b during heating when forming the hydrogen electrode layer 6.

The second pores 6c are connected to each other. This forms gas flow paths expanding three-dimensionally within the hydrogen electrode layer 6. The second pores 6c are voids between the second electrically conductive particles 6a and the ion-conductive particles 6b.

It is preferable that a mean equivalent circle diameter of the plurality of first pores 5c in the gas diffusion layer 5 is smaller than a mean equivalent circle diameter of the plurality of second pores 6c in the hydrogen electrode layer 6. That is, it is preferable that the gas diffusion layer 5 includes more small-diameter pores than the hydrogen electrode layer 6. Further, it is preferable that the porosity of the gas diffusion layer 5 is larger than the porosity of the hydrogen electrode layer 6. That is, it is preferable that the volume ratio of the gas channel per unit volume of the gas diffusion layer 5 is larger than the volume ratio of the gas channel per unit volume of the hydrogen electrode layer 6.

This can improve the gas diffusion properties of the gas diffusion layer 5, and can therefore allow the gas to be diffused not only in the thickness direction but also in the surface direction in the gas diffusion layer 5. Accordingly, the gas diffusion layer 5 can efficiently supply the source gas supplied from the connecting holes 11 in the metal substrate 10 to the entire hydrogen electrode layer 6, and efficiently discharge the gas produced in the hydrogen electrode layer 6 from the entire hydrogen electrode layer 6 to the connecting holes 11.

Note that the mean equivalent circle diameter of the pores is the arithmetic mean value of equivalent circle diameters of the plurality of pores. The equivalent circular diameter of a pore is the diameter of a circle that has the same area as the area of the pore that appears in a cross section along the thickness direction.

The porosities of the gas diffusion layer 5 and the hydrogen electrode layer 6 can be acquired as follows. The method of measuring the porosity is common to both layers, and the following is a description of the case of acquiring the porosity of the gas diffusion layer 5 as an example.

First, hydrogen is supplied to the gas diffusion layer 5 and the hydrogen electrode layer 6 with the temperature of the electrolytic cell 1 raised to 750° C., thereby reducing the electrically conductive materials contained in the gas diffusion layer 5 and the hydrogen electrode layer 6.

Next, the temperature of the electrolytic cell 1 is lowered while maintaining the reducing atmosphere, and the electrolytic cell 1 is cut along the thickness direction (Z-axis direction) to expose cross sections of the gas diffusion layer 5 and the hydrogen electrode layer 6.

Next, after performing precision mechanical polishing on the cross sections, ion milling processing is performed using IM4000 manufactured by Hitachi High-Tech Corporation.

Next, a SEM image in which the cross section of the gas diffusion layer 5 is enlarged is acquired using an FE-SEM with an in-lens secondary electron detector at a magnification that allows the first electrically conductive particles 5a, the base material particles 5b, and the first pores 5c to be recognized (e.g. 5000 to 30000 times).

Next, the brightness differences between the first electrically conductive particles 5a, the base material particles 5b, and the first pores 5c are ternarized by classifying the brightness of the SEM image into 256 gradations. For example, the first electrically conductive particles 5a can be displayed in dark gray, the base material particles 5b can be displayed in light gray, and the first pores 5c can be displayed in black.

Next, an analysis image in which the first pores 5c are highlighted is acquired by image-analyzing the SEM image using image analysis software HALCON manufactured by MVTec (Germany).

Next, the total area of the first pores 5c (gas phase) is acquired from the analysis image, and the porosity in one analysis image is calculated by dividing the total area of the first pores 5c by the area of the entire analysis image.

Then, the above analysis is performed at five randomly selected positions in the same cross section of the gas diffusion layer 5, and the arithmetic mean value of the porosities calculated at the five positions is defined as the porosity of the gas diffusion layer 5.

It is preferable that the number of first pores 5c per unit area of the gas diffusion layer 5 is greater than the number of second pores 6c per unit area of the hydrogen electrode layer 6, as shown in FIG. 4. This allows the gas to be diffused to every corner of the gas diffusion layer 5, thereby further improving the gas diffusion properties of the gas diffusion layer 5. The number of pores can be obtained from the analysis image used to obtain the porosity.

Further, it is preferable that the mean neck diameter of the first electrically conductive particles 5a included in the gas diffusion layer 5 is smaller than the mean neck diameter of the second electrically conductive particles 6a included in the hydrogen electrode layer 6. This makes it easier to form, in the gas diffusion layer 5, a structure that includes many small-diameter pores and has a large volume ratio of the gas channel.

The mean neck diameter of the first electrically conductive particles 5a is the arithmetic mean value of the neck diameters of the neck portions L1 of the first electrically conductive particles 5a. The neck diameter of each neck portion L1 is the width of the narrowest section between two first electrically conductive particles 5a. The mean neck diameter of the first electrically conductive particles 5a can be obtained by obtaining the arithmetic mean of the neck diameters of 10 neck portions L1 randomly selected in the analysis image used to obtain the porosity. The mean neck diameter of the first electrically conductive particles 5a is not specifically limited, but can be, for example, 0.05 μm or more and 0.5 μm or less.

Similarly, the mean neck diameter of the second electrically conductive particles 6a is the arithmetic mean value of the neck diameters of the neck portions M1 of the second electrically conductive particles 6a. The neck diameter of each neck portion M1 is the width of the narrowest section between two second electrically conductive particles 6a. The mean neck diameter of the second electrically conductive particles 6a can be obtained by obtaining the arithmetic mean of the neck diameters of 10 neck portions M1 randomly selected in the analysis image used to obtain the porosity. The mean neck diameter of the second electrically conductive particles 6a is not specifically limited, but can be, for example, 0.1 μm or more and 3 μm or less.

Further, it is preferable that the mean neck diameter of the base material particles 5b included in the gas diffusion layer 5 is smaller than the mean neck diameter of the ion-conductive particles 6b included in the hydrogen electrode layer 6. This makes it easier to form, in the gas diffusion layer 5, a structure that includes many small-diameter pores and has a large volume ratio of the gas channel.

The mean neck diameter of the base material particles 5b is the arithmetic mean value of the neck diameters of the neck portions L2 of the base material particles 5b. The neck diameter of each neck portion L2 is the width of the narrowest section between two base material particles 5b. The mean neck diameter of the base material particles 5b can be obtained by obtaining the arithmetic mean of the neck diameters of 10 neck portions L2 randomly selected in the analysis image used to obtain the porosity. The mean neck diameter of the base material particles 5b is not specifically limited, but can be, for example, 0.1 μm or less.

Similarly, the mean neck diameter of the ion-conductive particles 6b is the arithmetic mean value of the neck diameters of the neck portions M2 of the ion-conductive particles 6b. The neck diameter of each neck portion M2 is the width of the narrowest section between two ion-conductive particles 6b. The mean neck diameter of the ion-conductive particles 6b can be obtained by obtaining the arithmetic mean of the neck diameters of 10 neck portions M2 randomly selected in the analysis image used to obtain the porosity. The mean neck diameter of the ion-conductive particles 6b is not specifically limited, but can be, for example, 1 μm or more and 3 μm or less.

### Variations of Embodiment

Although the embodiment of the present invention has been described above, the present invention is not limited thereto, and various changes can be made without departing from the gist of the invention.

### Variation 1

In the present embodiment, the opening of each connecting hole 11 in the metal substrate 10 on the first principal surface 12 side is covered by the gas diffusion layer 5. However, this need not be the case. The gas diffusion layer 5 need not cover the opening of each connecting hole 11 on the first principal surface 12 side. That is, the gas diffusion layer 5 need not include the second portions 52. In this case, the gas diffusion layer 5 has through holes connected to the respective connecting holes 11, and the gas can thus be more efficiently supplied and discharged through these through holes.

### Variation 2

In the above embodiment, the electrolytic cell 1 has been described as an example of an electrochemical cell. However, the electrochemical cell is not limited to an electrolytic cell. The term “electrochemical cell” is a general term for elements in which a pair of electrodes are disposed such that electromotive force is generated from the overall redox reaction in order to convert electrical energy to chemical energy, and elements for converting chemical energy into electrical energy. Accordingly, electrochemical cells include, for example, fuel cells that use oxide ions or protons as carriers.

### REFERENCE SIGNS LIST

1 Electrolytic cell
10 Metal substrate
11 Connecting hole
12 First principal surface
13 Second principal surface
20 Cell body
5 Gas diffusion layer
5a First electrically conductive particle
5b Base material particle
5c First pore
L1 Neck portion of first electrically conductive particles
L2 Neck portion of base material particles
6 Hydrogen electrode layer
6a Second electrically conductive particle
6b Ion-conductive particle
6c Second pore
M1 Neck portion of second electrically conductive particles
M2 Neck portion of ion-conductive particles
7 Electrolyte layer
8 Reaction-preventing layer
9 Oxygen electrode layer
30 Channel member
30a Channel

1. An electrochemical cell comprising:
a metal substrate having a principal surface and a plurality of connecting holes formed in the principal surface; and
a cell body disposed on the principal surface,
the cell body having:
a gas diffusion layer disposed on the principal surface, the gas diffusion layer being electrically conductive;
a first electrode layer disposed on the gas diffusion layer;
a second electrode layer; and
an electrolyte layer disposed between the first electrode layer and the second electrode layer, wherein
the gas diffusion layer includes a first portion sandwiched between the principal surface and the first electrode layer and a plurality of second portions sandwiched between the plurality of connecting holes and the first electrode layer, and
the first portion has a gas flow path having a length equal to 20% or more of a total thickness of the first portion in a thickness direction thereof in a cross-section of the first portion along the thickness direction.

2. The electrochemical cell according to claim 1, wherein the gas flow path extends in the thickness direction.

3. The electrochemical cell according to claim 2, wherein
a ratio of the length of the gas flow path in the thickness direction to a width of the gas flow path in a surface direction perpendicular to the thickness direction is 10 or more.

4. The electrochemical cell according to claim 1, wherein
the gas flow path is separated from the first electrode layer.
